(19) United States
(12) Patent Application Publication
(10) Pub. No.: US 2015/0251772 A1
(43) Pub. Date: Sep. 10, 2015

(54) SYSTEM AND METHOD OF MAPPING USER NOTES TO FLIGHT CHARTS

(71) Applicant: The Boeing Company, Chicago, IL (US)

(72) Inventor: Thomas Letts, Lakewood, CO (US)

(73) Assignee: The Boeing Company, Chicago, IL (US)

(21) Appl. No.: 14/203,434

(22) Filed: Mar. 10, 2014

(51) Int. Cl. B64D 45/00

(52) U.S. Cl. CPC B64D 45/00

(57) ABSTRACT

A particular embodiment, a method includes receiving, at an electronic flight bag device, input corresponding to a user note. The method further includes generating, at the electronic flight bag device, data that maps the user note to a flight chart identifier associated with a flight chart. The method also includes receiving a replacement flight chart. The replacement flight chart corresponds to an updated version of the flight chart. The method includes storing the replacement flight chart such that the flight chart identifier is associated with the replacement flight chart.

### FIELD

The present disclosure generally relates to electronic flight bags and more particularly to apparatus, systems, and methods for mapping user notes to flight charts.

### BACKGROUND

An electronic flight bag provides a user (e.g., a pilot, copilot, navigator, etc.) with electronically stored flight charts that may be used during planning and execution of a flight plan. Information included in the flight charts may include airport and runway locations, approach procedures, taxi procedures, radio frequencies, weather patterns, potential hazards, and other information useful to the user. The flight charts may be periodically updated to ensure the user has access to currently available information.

Some electronic flight bags enable a user to edit a flight chart to include a user note particular to the user. In these electronic flight bags, the user note is associated with the particular flight chart that was edited. For example, if the user desires to add the same user note to an additional flight chart, the user must edit the additional flight chart as well. Further, if the flight chart is updated (by replacing the flight chart with an updated flight chart) the user note is lost.

### SUMMARY

An electronic flight bag is disclosed that may receive a user note regarding a flight chart via a touchscreen interface. The electronic flight bag includes a user note data structure to map the user note to a flight chart identifier (e.g., a flight chart number) corresponding to the flight chart. If the flight chart is updated, the user note remains mapped to the flight chart identifier, and therefore is automatically mapped to the updated flight chart. The user note data structure also enables a user note to be mapped to multiple flight charts

In an embodiment, a method includes receiving, at an electronic flight bag device, input corresponding to a user note. The method further includes generating, at the electronic flight bag device, data that maps the user note to a flight chart identifier associated with a flight chart. The method also includes receiving a replacement flight chart. The replacement flight chart corresponds to an updated version of the flight chart. The method includes storing the replacement flight chart such that the flight chart identifier is associated with the replacement flight chart.

In another embodiment, a non-transitory computer-readable medium stores instructions. The instructions, when executed by a processor, cause the processor to perform operations. The operations include receiving input corresponding to a user note. The operations further include generating data that maps the user note to a flight chart identifier associated with a flight chart. The operations also include receiving a replacement flight chart. The replacement flight chart corresponds to an updated version of the flight chart. The operations include storing the replacement flight chart such that the flight chart identifier is associated with the replacement flight chart.

In another embodiment, a system includes a processor and a memory accessible to the processor. The memory stores a flight chart data structure. A flight chart is identified within the flight chart data structure by a flight chart identifier. The flight chart identifier is distinct from a version identifier corresponding to the flight chart. The system further includes a note data structure. A user note of the note data structure is mapped to the flight chart using the flight chart identifier. The system also includes a display interface accessible to the processor to send data corresponding to the flight chart and data corresponding to the user note to a display device.

The described features, functions, and advantages may be achieved independently in various embodiments or may be combined in yet other embodiments further details of which can be seen with reference to the following description and drawings.

### BRIEF DESCRIPTION OF THE DRAWINGS

FIG. 1 is a block diagram of a particular embodiment of a system for mapping user notes to flight charts;

FIG. 2A is an illustration depicting an exemplary embodiment of a flight chart data structure;

FIG. 2B is an illustration depicting an exemplary embodiment of a user note data structure;

FIG. 3A is an illustration depicting a second exemplary embodiment of a flight chart data structure;

FIG. 3B is an illustration depicting a second exemplary embodiment of a user note data structure;

FIG. 4 is an illustration depicting an exemplary embodiment of a graphical user interface (GUI) for mapping user notes to flight charts;

FIG. 5 is an illustration depicting a second exemplary embodiment of a GUI for mapping user notes to flight charts;

FIG. 6 is an illustration depicting a third exemplary embodiment of a GUI for mapping user notes to flight charts;

FIG. 7 is an illustration depicting an exemplary embodiment of an updated GUI that includes an updated flight chart;

FIG. 8 is an illustration depicting an exemplary embodiment of a GUI for displaying user notes;

FIG. 9 is a flowchart depicting an exemplary embodiment of a method of mapping user notes to flight charts;

FIG. 10 is a flowchart depicting an exemplary embodiment of a method of displaying user notes associated with flight charts;

FIG. 11 is a flowchart depicting an exemplary embodiment of a method of displaying a replacement chart; and

FIG. 12 is an illustration of a block diagram of a computing environment including a general purpose computing device configured to support embodiments of computer-implemented methods and computer-executable program instructions (or code) according to the present disclosure.

### DETAILED DESCRIPTION

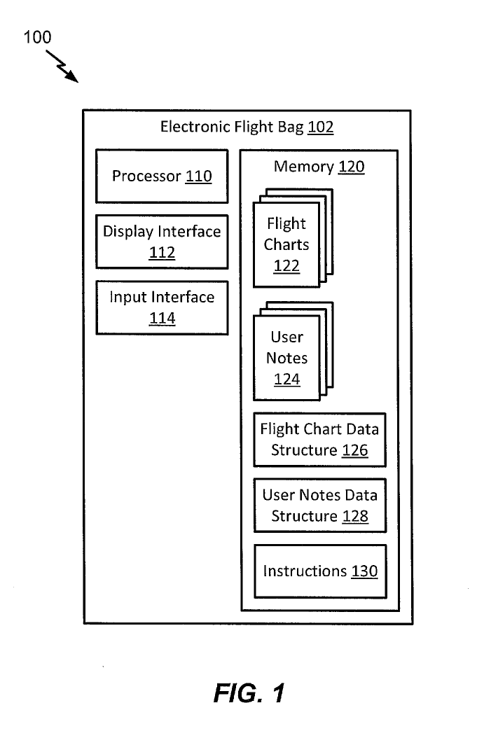

FIG. 1 is a block diagram of an exemplary embodiment of a system 100 for mapping user notes to flight charts. The system 100 includes an electronic flight bag 102. The electronic flight bag includes a processor 110, a display interface 112, an input interface 114, and a memory 120. The memory 120 may include one or more flight charts 122, one or more user notes 124, a flight chart data structure 126, a user note data structure 128, and processor-executable instructions 130. The flight chart data structure 126 and the user note data structure 128 may enable mapping a single user note of the one or more user notes 124 to multiple flight charts of the one or more flight charts 122. Further, maintaining the user note data structure 128 independently of the one or more flight charts 122 and the flight chart data structure 122 enables a mapping of a user note to a particular flight chart to persist after the particular flight chart is updated.

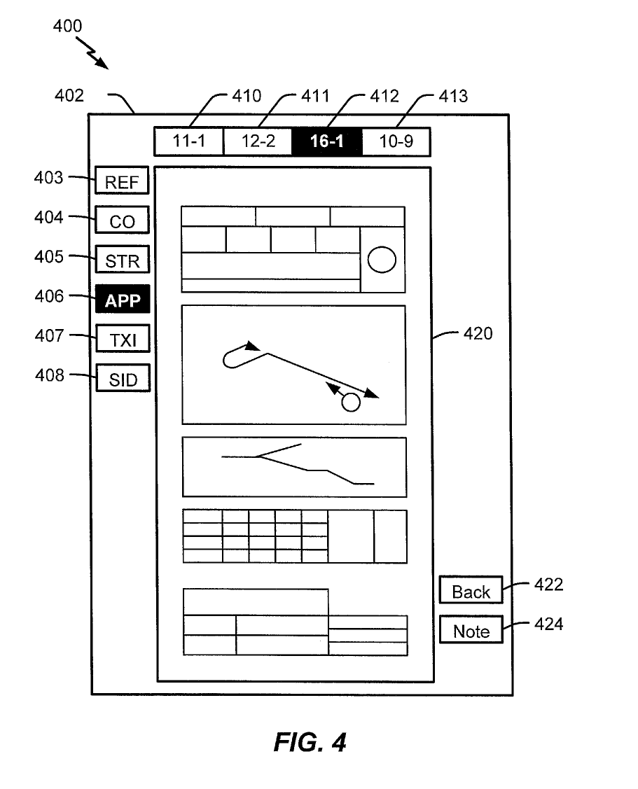

The display interface 112 may enable the electronic flight bag 102 to send generated displays (e.g., graphical user interfaces (GUIs)) to a display device (e.g., an LCD display, a touchscreen display, etc.). The generated displays may be based on the one or more flight charts 122, the one or more user notes 124, one or more additional display elements, or any combination thereof. Examples of particular embodiments of GUIs that may be displayed via the display interface 112 are described with reference to FIG. 4-FIG. 8.

The input interface 114 may enable the electronic flight bag 102 to receive user input corresponding to a user note (e.g., a command to create, modify, and/or delete text of the user note). The electronic flight bag 102 may also receive, via the input interface 114, user input corresponding to a displayed flight chart (e.g., selection of an indicator indicating that a user note is mapped to the flight chart). The input interface 114 may also enable the electronic flight bag 102 to receive user input corresponding to a search request. For example, the search request may include a request to search the one or more user notes 124 based on a search term, a user note category (e.g., personal, non-personal, etc.), a date, a chart number, a note identifier, a geographical region, a chart category (e.g., reference, company, standard terminal arrival, approach, taxi, standard instrument departure), other search criteria, or any combination thereof. The input interface 114 may include a touchscreen interface, a keyboard interface, another type of input interface, or any combination thereof. For example, the input interface may be a touchscreen interface and the user input corresponding to a user note may include data associated with drawings made on the surface of a touchscreen of the electronic flight bag using a finger, a specialized drawing instrument, another drawing means, or any combination thereof.

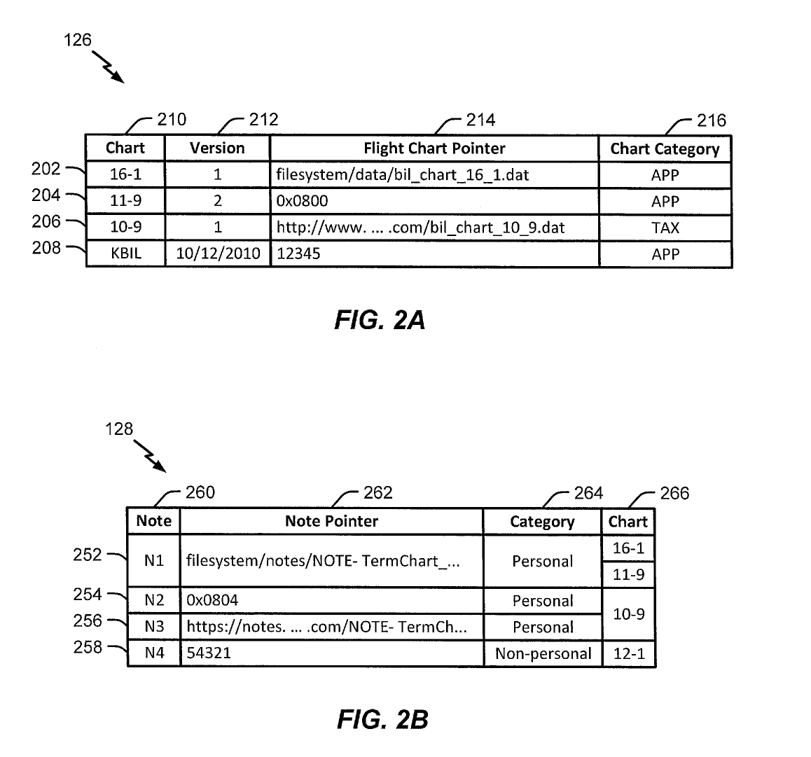

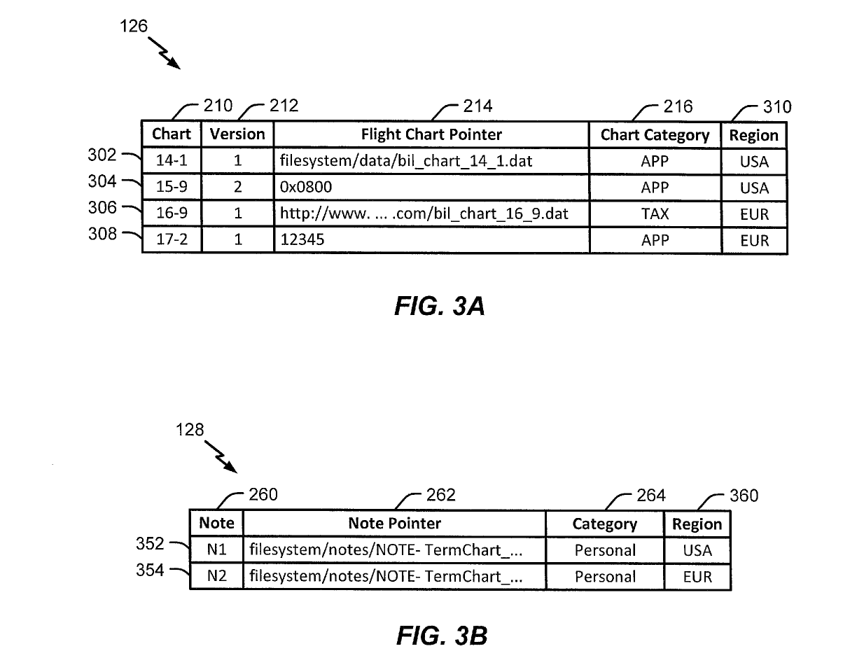

The one or more flight charts 122 may include data useful for planning and execution of a flight plan. Information included in the flight charts may include airport and runway locations, approach procedures, taxi procedures, radio frequencies, weather patterns, potential hazards, and other information useful to a user. The one or more flight charts may include any type of aeronautical chart, including but not limited to en-route charts, terminal charts, sectional charts, other types of charts, or any combination thereof. Further, the flight charts may be periodically updated to ensure the user has access to currently available information. The flight chart data structure 126 may be used to index the one or more flight charts 122. Examples of particular embodiments of the flight chart data structure 126 are described with reference to FIG. 2A and FIG. 3A.

The one or more user notes 124 may include data input by a user. The data may indicate special procedures, frequently encountered weather conditions, recommended restaurants at a particular airport, and any other information that a user may find useful to include on the particular flight chart and that may not be included on the flight chart by default. The user note data structure 128 may be used to index the one or more user notes 124 and to map the one or more user notes 124 to one or more flight chart identifiers within the flight chart data structure 126. Because the one or more user notes 124 are mapped to the one or more flight charts 122 indirectly (via the flight chart identifiers), the one or more user notes 124 may persist in being mapped to the one or more flight charts 122 when the one or more fight charts 122 are updated (e.g., replaced by updated flight charts). Examples of particular embodiments of the user note data structure 128 are described with reference to FIG. 2B and FIG. 3B. Additionally, a single user note may be mapped to more than one flight chart. Thus, by editing or deleting a user note, the user edits or deletes the user note for multiple flight charts at one time.

In operation, the electronic flight bag 102 may be configured to receive (e.g., via the input interface 114) input corresponding to a user note. For example, the input may include a user request to create an empty user note. In response to the user request, the electronic flight bag 102 may generate the empty note and generate data (e.g., an entry in the user note data structure 128) that maps the empty user note to a flight chart identifier (stored at the flight chart data structure 126) associated with a flight chart of the one or more flight charts 122. As another example, the user note may be an existing user note. In this case, based on the input, the electronic flight bag 102 may display or enable editing of the existing user note. The input may also include a request to map the existing user note to a particular flight chart or to multiple flight charts of the one or more flight charts 122. A particular user note may be mapped to any number of flight chart identifiers stored in the flight chart data structure 126, thereby mapping the user note to any number of flight charts of the one or more flight charts 122. To illustrate, the electronic flight bag 102 may generate data that maps the user note to a first flight chart identifier associated with a first flight chart and to a second flight chart identifier associated with a second flight chart. In a particular embodiment, a mapping data structure may be used to map the user notes to the flight charts. For example, a mapping data structure may facilitate mapping many-to-many relationships (e.g., more than one flight chart to more than one user note).

The electronic flight bag 102 may receive second input corresponding to the user note. The second input may include a request to edit or delete the user note. For example, a user may request to insert data into the note via the input interface 114. To illustrate, the input interface 114 may be a touchscreen interface and a user may edit the user note by drawing on the touchscreen with a finger or another writing instrument. The request to edit the user note may include a request to add information to the note, undo previously added information, cut a portion of information from the note, perform another editing function, or any combination thereof. Editing or deleting the user note results in the user note being edited or deleted for each flight chart to which the user note is mapped. In a particular embodiment, a request to edit or delete the user note indicates a subset of flight charts for which the user note is to be edited or deleted. For example, a request to delete the user note may include data indicating a particular subset of flight charts for which the user note is to be deleted. As an illustrative example, the particular subset of flight charts may be associated with a geographical region. In response to the request to delete the user note, the user note data structure 128 may be modified such that mappings of the user note to flight chart identifiers associated with flight charts of the geographical region are removed while other mappings of the user note to flight chart identifiers associated with flight charts of other geographical regions are unchanged.

The electronic flight bag 102 may be further configured to receive a replacement flight chart corresponding to an updated version of the flight chart. For example, a user may download a set of updated flight charts from a database of updated flight charts via a network connection (e.g., an internet connection, a local area connection, a wide area connection, a direct computer link, etc.). Alternatively, the user may upload the set of updated flight charts to the electronic flight bag 102 via another medium (e.g., a solid state memory device, a CD-ROM device, magnetic memory device, etc.). The set of updated flight charts may include the replacement flight chart. Both the flight chart and the replacement flight chart may be associated with a same flight chart identifier.

In response to receiving the replacement flight chart, the replacement flight chart may be stored at the memory 120 with the one or more flight charts 122. The replacement flight chart may be stored such that the flight chart identifier is associated with the replacement flight chart. For example, the flight chart data structure 126 may be updated to map the flight chart identifier corresponding to the flight chart to the replacement flight chart. Alternatively, a naming scheme of the replacement flight chart may enable the flight chart identifier to automatically map to the replacement flight chart. As an illustrative example, the flight chart identifier may include a portion of a file name. The portion of the file name may be common to both the flight chart and the replacement flight chart such that by adding the replacement flight chart to the one or more flight charts 122, the flight chart identifier automatically maps to the replacement flight chart instead of, or in addition to, the flight chart. Alternatively, the flight chart data structure may include a flight chart identifier and the version identifier and the flight chart data structure may map the user note to a most recent version of the flight chart.

Generating data to map a user note to multiple flight chart identifiers enables a user of the electronic flight bag 102 to add, edit, and/or delete a user note for multiple flight charts at the same time, without the time consuming process of adding, editing, and/or deleting the user note for each flight chart individually. Thus, a user experience is improved as compared to electronic flight bags that do not map a user note to multiple flight chart identifiers. Further, by storing the replacement flight chart such that the flight chart identifier is automatically associated with the replacement flight chart, a user note associated with a flight chart may automatically be associated with the replacement flight chart, and the user does not need to recreate user notes after updating the one or more flight charts 124. Thus, the user experience is improved as compared to electronic flight bags that do not store replacement flight charts such that flight chart identifiers are automatically associated with the replacement flight charts.

Further operations that may be performed at the electronic flight bag 102 are described with reference to FIG. 2A-FIG. 8.

FIG. 2A is an illustration depicting an exemplary embodiment of the flight chart data structure 126 of FIG. 1 that includes records 202, 204, 206, 208 and fields 210, 212, 214, 216. Each record 202, 204, 206, 208 may correspond to a flight chart (e.g., the one or more flight charts 122 of FIG. 1). As such, the flight chart data structure 126 may include any number of records and the number of records may change dynamically based on a number of flight charts stored at electronic flight bag 102. For example, if a flight chart is added to the one or more flight charts 122, a record corresponding to the flight chart may be added to the flight chart data structure 126. The fields 210, 212, 214, 216 may include a flight chart identifier field 210, a flight chart version field 212, a flight chart pointer field 214, and a flight chart category field 216. For each field of each record, the flight chart data structure 126 may store data indicating a property and/or other type of descriptor associated with a flight chart.

The flight chart identifier field 210 may correspond to a flight chart identifier that may include a flight chart index number (e.g., “16-1”, “11-9”, or “10-9”) as depicted for the records 202, 204, 206, an airport symbol (e.g., “KBIL”) as depicted for the record 208, another form of flight chart identifier, or any combination thereof. The flight chart identifier field 210 may be used to map a user note to flight chart corresponding to a particular record. The flight chart may include any type of aeronautical chart, including but not limited to an en-route chart, a terminal chart, a sectional chart, another type of chart, or any combination thereof.

The flight chart version field 212 may be used to store data that includes a version identifier (e.g., “1”, “2”, etc.) as depicted for the records 202, 204, 206, a date (e.g., “10/12/2012”) as depicted for the record 208, another form of version identifier, or any combination thereof. The version identifier may be used to determine a most recently updated version of a flight chart. For example, if a user requests to open a flight chart of the one or more flight charts 122 of FIG. 1, the version identifier may be used to select a most recently updated (e.g., current) version of the flight chart.

The flight chart pointer field 214 may be used to store a flight chart pointer usable to locate a flight chart associated with a record. For example, the flight chart pointer may include a file name and a file path (e.g., “filesystem/data/bil_chart_16_1.dat”) as shown for the record 202, a memory location (e.g., “0×0800”) as shown for the record 204, a uniform resource locator (URL) corresponding to an external server or remote device (e.g., “http://www . . . com/bil_chart_10_9.dat”) as shown for the record 206, an index value (e.g., “12345”) as shown for the record 208, another form of pointer, or any combination thereof.

The flight chart category field 216 may be used to store data that includes a category identifier (e.g., “APP”, “TAX”, etc.). The category identifier may identify a category of a flight chart corresponding to a record. Flight charts may be categorized under the following categories: reference, company, standard terminal arrival, approach, taxi, standard instrument departure, another flight chart category, or any combination thereof. The flight chart category field 216 may be used by a user to search for a set of flight charts of the one or more flight charts 122 stored at the electronic flight bag 102. The flight chart category field 216 may also be used to map a user note to each flight chart corresponding to a particular category.

By including a flight chart identifier field 210 independent of a flight chart version number field 212, the flight chart data structure 126 may enable an electronic flight bag (e.g., the electronic flight bag 102 of FIG. 1) to updated a flight chart without changing a flight chart identifier associated with the flight chart. A user note mapped to the flight chart identifier may be automatically mapped to the updated flight chart, thereby enabling a user to update the flight chart without removing the user note. While the flight chart data structure 126 is depicted as including four fields, the flight chart data structure 126 may include more than four or fewer than four fields to describe various properties and/or descriptors of the one or more flight charts 122.

FIG. 2B is an illustration depicting an exemplary embodiment of the user note data structure 128. In the embodiment illustrated in FIG. 2B, the user note data structure 128 includes records 252, 254, 256, 258 and fields 260, 262, 264, 266. The records 252, 254, 256, 258 may correspond to user notes (e.g., the one or more user notes 124 of FIG. 1). Similar to the flight chart data structure 126, the user note data structure 128 may include more than four or fewer than four records and the number of records may change dynamically based on a number of user notes stored at the electronic flight bag 102. The fields 260, 262, 264, 266 may include a user note identifier field 260, a user note pointer field 262, a user note category field 264, and a flight chart identifier field 266.

The user note identifier field 260 may be used to store data corresponding to a user note identifier associated with a user note of the one or more user notes 124 of FIG. 1. The user note identifier may include any information usable to distinctly identify the user note (e.g., “N1”, “N2”, “N3”, “N4”). The user note identifier field may be usable to retrieve a particular user note from the one or more user notes 124.

The user note pointer field 262 may be used to store a user note pointer usable to locate a user note (e.g., a data file) associated with a record. For example, the user note pointer may include a file name and file path (e.g., “filesystem/data/NOTE-TermChart . . . ”) as shown for the record 252, a memory location (e.g., “0×0804”) as shown for the record 254, a uniform resource locator (URL) corresponding to an external server or remote device (e.g., “http://notes . . . com/NOTE-TermCh . . . ”) as shown for the record 256, an index value (e.g., “54321”) as shown for the record 258, another type of pointer, or any combination thereof.

The user note category field 264 may be used to store data that includes a category identifier (e.g., “Personal”, “Non-personal”, etc.). The category identifier may identify a category of a user note corresponding to a record. The user note category field 264 may be used by a user to search for a set of user notes of the one or more user notes 124 stored at the electronic flight bag 102.

The flight chart identifier field 266 may be used to map user notes associated with the records 252, 254, 256, 258 to flight chart identifiers corresponding to the flight chart identifiers of the flight chart data structure 126. For example, referring to the record 252, the flight chart identifier field 266 may be used to store a first flight chart identifier (e.g., “16-1”) and a second flight chart identifier (e.g., “11-9”), thereby mapping a user note (e.g., “N1”) corresponding to the record 252 to a first flight chart corresponding to the record 202 of the flight chart data structure 126 of FIG. 2A and to a second flight chart corresponding to the record 204 of the flight chart data structure 126. A user note may be mapped to one flight chart identifier (as shown by the record 258), two flight chart identifiers (as shown by the record 252), or more than two flight chart identifiers.

Further, multiple user notes may be mapped to a single flight chart. For example, a first user note (e.g., “N2”) corresponding to the record 254 and a second user note (e.g., “N3”) corresponding to the record 256 may be mapped to a flight chart identifier (e.g., “10-9”). Thus, in the example depicted in FIG. 2B, both the first user note and the second user note are mapped to a flight chart (e.g., “10-9”) that corresponds to the record 206 of the flight chart data structure 126 of FIG. 2A. Accoringly, zero, one, two, or more user notes may be mapped to a flight chart.

By associating multiple flight chart identifiers with a single note, the user note data structure 120 and the flight chart data structure 126 enable a user to associate a single user note with multiple flight charts without recreating the note for each flight chart. Further, a single flight chart may be associated with multiple user notes, increasing the amount of information a user may associate with a flight chart. Thus, a user experience is improved as compared to electronic flight bags that associate a single user note with a single flight chart.

FIG. 3A is an illustration depicting a second exemplary embodiment of the flight chart data structure 126 that includes records 302, 304, 306, 308 corresponding to flight charts. The flight chart data structure 126 may include a region field 310 that may be used to store information indicating a region (e.g., state, country, continent, other region, etc.). For example, using the region field 310, the records 302, 304 may store information indicating a region (e.g., “USA”). Both the flight charts associated with the records 302, 304, may correspond to locations within the United States. Further, the records 306, 308 may include information indicating another region (e.g., “EUR”). Both the flight charts associated with the records 306, 308 may correspond to locations within Europe. The region field 310 may correspond to any geographical or spatial region and is not limited to the United Stated and Europe. The flight chart data structure 126 of FIG. 3A may be used in conjunction with the user note data structure of FIG. 3B to enable user notes to be mapped to flight charts based on regions instead of, or in addition to, flight chart identifiers. Although the flight chart data structure 126 in FIG. 3A designates region using a specific field, in other embodiments, the region may be indicated in another manner. For example, the flight chart identifier may include a string or value that indicates a region to which the flight chart applies. To illustrate, in FIG. 3A, “14” of the flight chart identifier “14-1” may denote a region associated with the flight chart.

FIG. 3B is an illustration depicting a second exemplary embodiment of a user note data structure 128 that includes records 352, 357. The user note data structure 128 may include a region field 360 that may be used to store information that maps a user note to a set of flight charts corresponding to a region. For example, a user note (e.g., “N1”) corresponding to the record 352 may be mapped to each flight chart associated with the United States (depicted as “USA” under the region field 360).

Flight charts (e.g., “14-1” and “15-9”) associated with the records 302, 304 of FIG. 3A may be associated with the United States (depicted as “USA” under the region field 310). Thus, the note corresponding to the record 352 may be associated with the flight chart corresponding to the record 302 and the flight chart associated with the record 304.

By storing regional information (e.g., in a region field 310), the flight chart data structure 126 may enable user notes to be mapped to flight charts based on regions instead of based on flight chart identifiers. When the user note is edited or deleted, the user note is edited or deleted for each flight chart associated with the regional information.

In the particular exemplary embodiments depicted in FIG. 2A-FIG. 3B, the flight chart data structures and the user note data structures are depicted as tables. Alternatively, the flight chart data structures and user note data structures may be implemented as extensible markup language (XML) files, comma separated value (CSV) files, a hierarchical filing system, another form of data structure, or any combination thereof.

FIG. 4 is an illustration depicting an exemplary embodiment of a graphical user interface (GUI) 400 for mapping user notes to flight charts that includes a display 402. The display 402 includes selectable category options 403-408 to search for flight charts (e.g., of the one or more flight charts 122 of FIG. 1) that correspond to a particular category. The display 402 further includes selectable chart options 410-413 to display a flight chart 420. Although FIG. 4 depicts the flight chart 420 as a terminal chart, the flight chart 420 may include any type of aeronautical chart, including but not limited to an en-route chart, a terminal chart, a sectional chart, another type of chart, or any combination thereof. The display 402 also includes one or more selectable navigation options (e.g., a back option 422) and a selectable user note option 424. By including the selectable user note option 424, the display 402 enables a user to create, view, and/or edit, a user note corresponding to the flight chart 420. The GUI 400 may be displayed at the electronic flight bag 102 via the display interface 112 of FIG. 1. Further, the GUI 400 may be dynamically generated by the processor 110 based on the computer-readable instructions 130 stored in the memory 120.

The selectable category options 403-408 may include a reference option 403, a company option 404, a standard terminal arrival option 405, an approach option 406, a taxi option 407, and a standard instrument departure option 408. The selectable category options 403-408 may enable a user to find flight charts that correspond to a particular category. For example, when a selectable category option (e.g., the approach option 406) is selected by a user, a list of flight charts associated with a corresponding category (e.g., an approach category) may be displayed to the user. The user may select a particular flight chart of the list of flight charts for inclusion at the display 402.

The selectable chart options 410-413 may correspond to flight charts that have been selected by the user for inclusion at the display 402. For example, the user may have selected a first flight chart 410, a second flight chart 411, a third flight chart 412, and a fourth flight chart 413, for inclusion at the display 402. By selecting a particular selectable chart option, the display 402 may be updated to include the flight chart 420, which may correspond to the selected chart option.

After selecting a particular category and/or a particular flight chart, the user may use the selectable user note option 424 to create, view, and/or edit a user note corresponding to the particular category, the particular flight chart, or both. For example, if a user selects a particular flight chart (e.g., by selecting the selectable chart option 412 as depicted in FIG. 4) and there is not a preexisting note corresponding to the particular flight chart, then the user may use the selectable user note option 424 to send a request (e.g., via the input interface 114 of FIG. 1) to make a new note. In response to the request, an empty note may be generated and data that maps the empty note to the particular flight chart may be stored (e.g., at the user note data structure 128 of FIG. 1). The user may then edit the empty note to include user specific content. As another example, if a user selects a particular flight chart category (e.g., by selecting the selectable category option 406 as depicted in FIG. 4), then the user may use the selectable user note option 424 to make a new note corresponding to the particular flight chart category. To illustrate, data may be stored (e.g., at the user note data structure 128) that maps the user note to each flight chart associated with the particular category. Thus, the selectable user note option 424 enables a user to create a new user note corresponding to a particular flight chart, or to a particular category of flight charts.

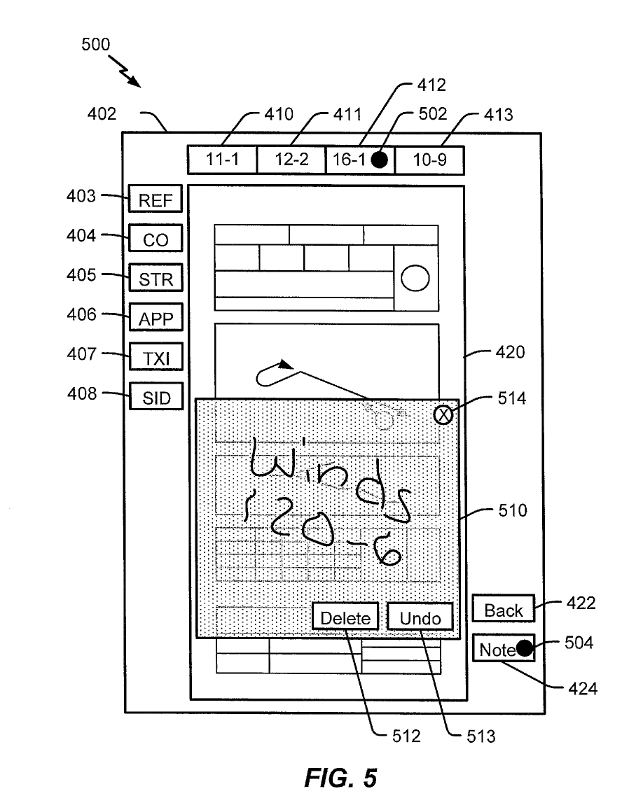

FIG. 5 is an illustration depicting a second exemplary embodiment of a GUI 500 for mapping user notes to flight charts. During the generation of the display 402, the electronic flight bag 102 of FIG. 1 may be configured to determine whether an existing user note of the one or more user notes 124 is associated with the flight chart 420. In response to determining that the existing user note is associated with the flight chart 420, the display 402 may include one or more indicators 502, 504 indicating that the existing user note is mapped to the flight chart 420. In response to selection of the one or more indicators 502, 504, the display 102 may be updated to overlay a user note display 510 on the flight chart 420. The user note display 510 may be at least partially transparent to enable the user to view the underlying flight chart 420 simultaneously with the existing user note. In a particular embodiment, the user note display 510 is at least partially translucent. The display 402 may also include selectable controls 512, 513, 514 corresponding to the user note display 510. The selectable controls may include a delete option 512, an undo option 513, and a close option 514. In an embodiment, a user may edit the user note by drawing on the user note display 510 (e.g., via the input interface 114 of FIG. 1). Alternatively, the display 402 may further include an edit option (not shown) that is selected to enable editing the user note.

In operation, a user may edit the user note. For example, the GUI 500 may be displayed on a touchscreen and the user may draw on the user note display 510 with a finger. The user note display 510 may be updated to include data associated with the received drawing. In another example, the user may user a keyboard to edit the user note. The user may use the selectable controls 512-514 to further edit the user note. To illustrate, the user may delete the user note by selecting the delete option 512. In response to selection of the delete option 512, the user note may be removed (e.g., removed from the one or more user notes 124 of FIG. 1). The user may undo a most recent edit to the note by selecting the undo option 513. For example, if the user mistakenly strikes a touchscreen interface displaying the user note display 510 and causes an erroneous mark to be added to the user note, the user may remove the erroneous mark by selecting the undo option 513. When the user is finished editing and/or viewing the user note, the user note display 510 may be closed by selecting the close option 514.

By generating a user note display 510 that is partially transparent and by overlaying the user note display 510 onto the flight chart 420, the GUI 500 enables a user to view both the flight chart 420 and the user note display 510, thereby adding convenience to a user experience. Further, because the user note may be mapped to multiple flight charts as described with reference to FIG. 1-FIG. 3B, editing or removing the user note for the flight chart 420 may include editing or removing the user note for each of the multiple flight charts.

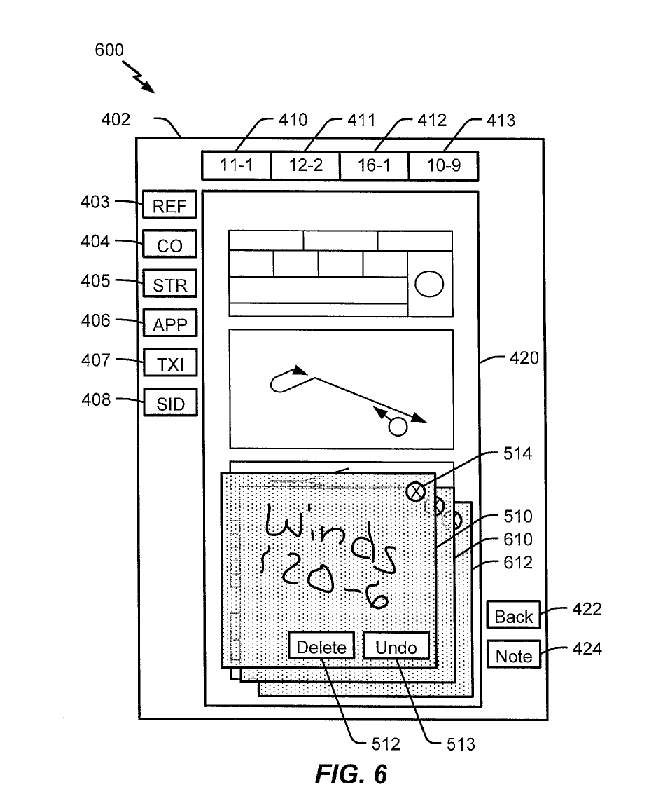

FIG. 6 is an illustration depicting a third exemplary embodiment of a GUI 600 for mapping user notes to flight charts. The GUI 600 may correspond to the GUI 400 of FIG. 4 and the GUI 500 of FIG. 5 and may further include multiple user note displays 610, 612. For example, the electronic flight bag 102 of FIG. 1 may generate data that maps a first user note, a second user note, and a third user note to a flight chart identifier associated with the flight chart 420. The user note display 510 may display the first user note, a second user note display 610 may display the second user note, and a third user note display 612 may display the third user note. Each of the user note displays 510, 610, 612, may be at least partially transparent and may be overlaid on the flight chart 420 enabling a user to view the flight chart at the same time as each of the user note displays 510, 610, 612. Each of the user note displays 510, 610, 612 may enable editing, viewing, and/or deleting of the corresponding user notes.

The user note displays 510, 610, 612 may be displayed in a cascaded configuration, as shown in FIG. 6, in a tiled configuration, in another display configuration, or any combination thereof. In a particular embodiment, one or more of the user note displays 510, 610, 612 may be moved within the display 402. For example, a user may perform a drag operation using an input interface (e.g., the input interface 114 of FIG. 1). Further, one or more of the user note displays 510, 610, 612 may be resized. To illustrate, a user may resize one or more of the user note displays 510, 610, 612 by performing a dragging operations on an edge of the one or more user note displays 510, 610, 612. The one or more user note displays 510, 610, 612 may also be sized automatically based on a number of user notes associated (e.g., via a flight chart identifier) with the flight chart 420. For example, the electronic flight bag 102 may automatically size the user note based on the number of user notes. By including multiple user note displays 610, 612 corresponding to multiple user notes associated with the flight chart 420, a user may access a large amount of information at the same time, increasing the effectiveness of the electronic flight bag.

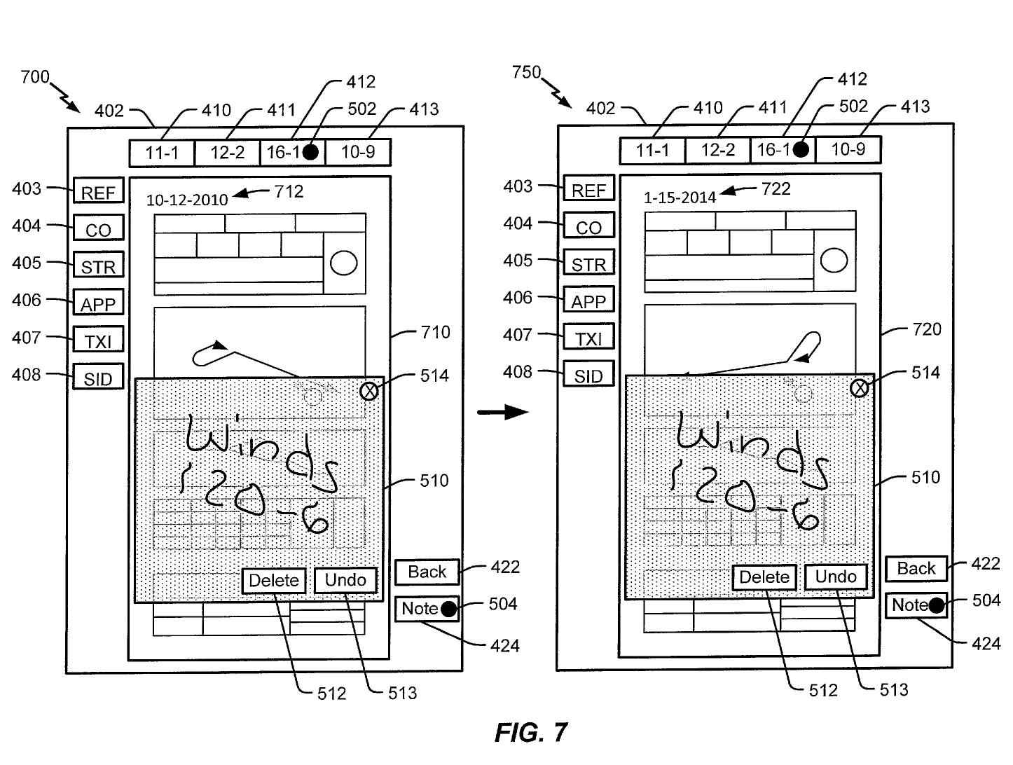

FIG. 7 is an illustration depicting an exemplary embodiment of an updated GUI that includes an updated flight chart. For example, a first GUI 700 may include a first flight chart 710. The first flight chart 710 may correspond to a first date 712. A user note corresponding to the first flight chart 710 may be displayed via the user note display 510, described with reference to FIG. 5. When the electronic flight bag receives an updated set of flight charts, a second GUI 750 may be generated. The second GUI 750 may include a second flight chart 720 (e.g., an updated flight chart) that corresponds to a second date 722. The first flight chart 710 and the second flight chart 720 may be associated with a same flight chart identifier. The flight chart identifier may independent of a first flight chart version identifier (e.g., corresponding to the first date 712) and independent of a second flight chart version identifier (e.g., corresponding to the second date 722). By mapping the user note to a flight chart identifier independent of a flight chart version identifier, as described with reference to FIG. 1-FIG. 3B, the user note display 510 may automatically display the user note corresponding to the second flight chart 720. Thus, the user note may persist even after a flight chart is updated or replaced.

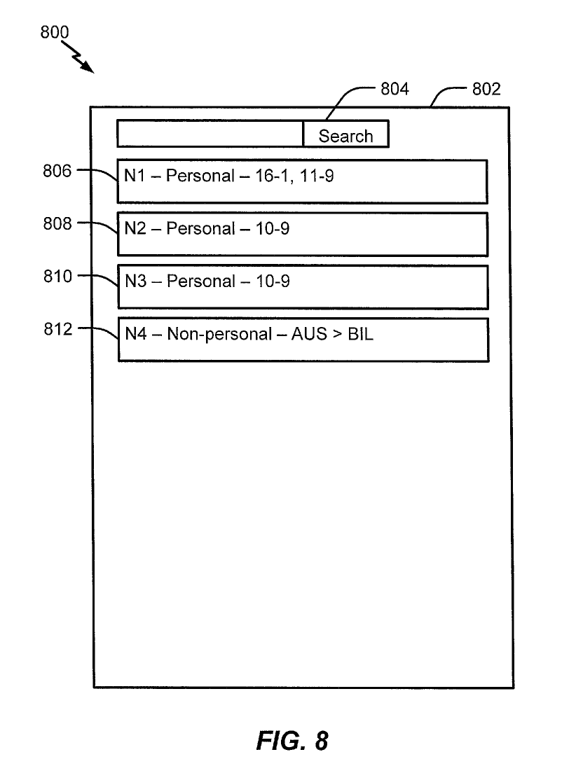

FIG. 8 is an illustration depicting an exemplary embodiment of a GUI 800 for displaying user notes. The GUI 800 includes a display 802. The display 802 may include a search option 804 and one or more entries 806, 808, 810, 812 indicating user notes. The GUI 800 may be generated by the electronic flight bag 102 of FIG. 1.

In operation, a user may use the search option 804 to generate a search request. For example, the search request may include a request to search the one or more user notes 124 based on a search term, a user note category (e.g., personal, non-personal, etc.), a date, a chart number, a note identifier, a geographical region, a chart category (e.g., reference, company, standard terminal arrival, approach, taxi, standard instrument departure), other search criteria, or any combination thereof. In response to the search request, the display 802 may be updated to include the one or more entries 806, 808, 810, 812. Each entry of the one or more entries 806, 808, 810, 812 may correspond to the request to search. For example, if the search request includes a request for each user note edited on a particular date, each of the entries 806, 808, 810, 812 may correspond to user notes edited on the particular date. Zero or more entries may be displayed in response to a search request.

Each of the entries 806, 808, 810, 812 may include information associated with a corresponding user note. For example, in FIG. 8, the entry 806 corresponds to a first user note. The first user note has the identification N1, is categorized as personal, and is mapped to multiple flight charts identified as 16-1 and 11-9. The entry 808 corresponds to a second user note. The second user note has the identification N2, is categorized as personal, and is mapped to a flight chart identified as 10-9. The third user note has the identification N3, is categorized as personal, and is mapped to the flight chart identified as 10-9. The fourth user note has the identification N4, is categorized as non-personal and is mapped to multiple flight charts identified by AUS and BIL.

As shown in FIG. 8, the GUI 800 may include a single note (e.g., N1) mapped to multiple flight charts (e.g., 16-1 and 11-9) and may also include multiple notes (e.g., N2 and N3) mapped to a single flight chart (e.g., 10-9). The GUI 800 provides a user with a convenient search mechanism for user notes.

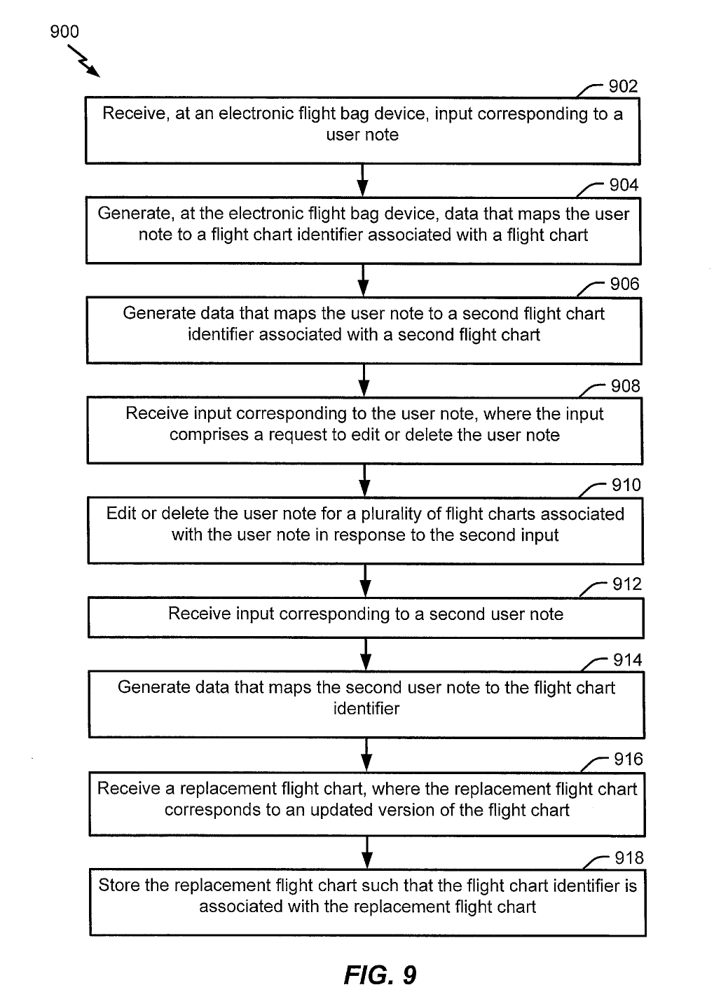

FIG. 9 is a flowchart depicting an exemplary embodiment of a method 900 of mapping user notes to flight charts. The method 900 may be performed by the electronic flight bag 102 of FIG. 1 and may be performed using the display 402 of FIG. 4-FIG. 6. The method 900 includes receiving, at an electronic flight bag device, input corresponding to a user note, at 902. For example, the electronic flight bag 102 of FIG. 1 may receive input via the input interface 114. The input may include a command to create, modify, and/or delete text of the user note. As another example, the input may include a selection of an indicator such as the indicator 502, 504 of FIG. 5 that indicates that a user note is mapped to a displayed flight chart. The input may be received via a touchscreen interface, a keyboard interface, another type of input interface, or any combination thereof.

The method 900 may further include generating, at the electronic flight bag device, data that maps the user note to a flight chart identifier associated with a flight chart, at 904. For example, the flight chart identifier may be stored at the flight chart data structure 126 of FIG. 1. Additional data stored at the flight chart data structure 126 may map the flight chart identifier to the flight chart. Data may be stored at the user note data structure 128 to map the user note to the flight chart identifier.

The method 900 may also include generating data that maps the user note to a second flight chart identifier associated with a second flight chart, at 906. For example, second data may be stored at the user note data structure 128 of FIG. 1 to map the user note to a second flight chart identifier stored at the flight chart data structure 126. The second flight chart identifier may be associated with a second flight chart. Thus, the user note may be mapped to a second flight chart.

The method 900 may include receiving input corresponding to the user note, where the input comprises a request to edit or delete the user note, at 908. For example, a user may draw on the user note display 510 of FIG. 5 using a touchscreen device. Additionally, the user may select the delete option 512 and/or the undo option 513.

The method 900 may further include editing or deleting the user note for a plurality of flight charts associated with the user note in response to the second input, at 910. For example, the user note may be mapped to multiple flight chart identifiers. By editing or deleting the user note, each flight chart to which the user note is mapped may reflect the edit or deletion. To illustrate, the user note corresponding to the record 252 of FIG. 2B may be edited or deleted and the change will be reflected for both the flight chart 16-1 and the flight chart 11-9.

The method 900 may also include receiving input corresponding to a second user note, at 912. For example, the input may include a command to create, modify, and/or delete text of a second user note. The second user note may already exist in, or be stored as an addition to, the one or more user notes 124 of FIG. 1.

The method 900 may include generating data that maps the second user note to the flight chart identifier, at 914. For example, second data may be stored at the user note data structure 128 to map the second user note to the flight chart identifier. Thus, the flight chart associated with the flight chart identifier may be mapped to both the user note and the second user note.

The method 900 may further include receiving a replacement flight chart, where the replacement flight chart corresponds to an updated version of the flight chart, at 916. For example, referring to FIG. 7, the flight chart 720 may be an updated version of the flight chart 710. The flight chart 720 may be received at the electronic flight bag 102 of FIG. 1 as part of a set of updated flight charts.

The method 900 may also include storing the replacement flight chart such that the flight chart identifier is associated with the replacement flight chart, at 918. For example, the flight chart data structure 126 of FIG. 1 may be updated to map the flight chart identifier corresponding to the flight chart to the replacement flight chart. Alternatively, a naming scheme of the replacement flight chart may enable the flight chart identifier to automatically map to the replacement flight chart. As an illustrative example, the flight chart identifier may include a portion of a file name. The portion of the file name may be common to both the flight chart and the replacement flight chart such that by adding the replacement flight chart to the one or more flight charts 122, the flight chart identifier automatically maps to the replacement flight chart instead of, or in addition to, the flight chart. Alternatively, the flight chart data structure may include a flight chart identifier and the version identifier and may map the flight chart to a most recent version of the flight chart.

Generating data to map a user note to multiple flight chart identifiers, as in the method 900, enables adding, editing, and/or deleting a user note for multiple flight charts at the same time, without the time consuming process of adding, editing, and/or deleting the user note for each flight chart individually. Thus, a user experience is improved as compared to electronic flight bags that do not map a user note to multiple flight chart identifiers. Further, by storing the replacement flight chart such that the flight chart identifier is automatically associated with the replacement flight chart, as in the method 900, a user note associated with a flight chart may automatically be associated with the replacement flight chart, and notes do not need to be recreate after flight charts are updated. Thus, the user experience is improved as compared to electronic flight bags that do not store replacement flight charts such that flight chart identifiers are automatically associated with the replacement flight charts.

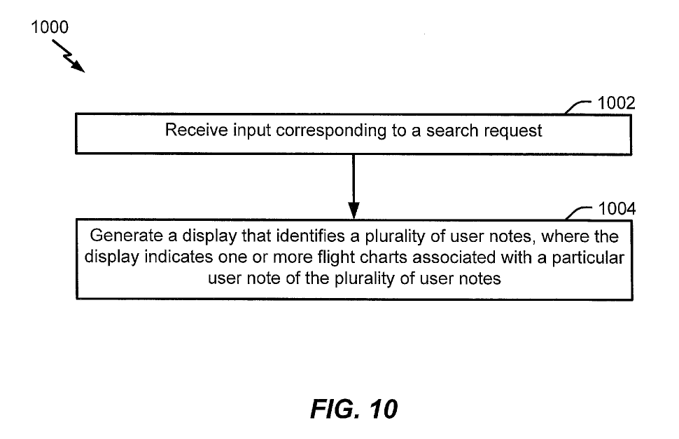

FIG. 10 is a flowchart depicting an exemplary embodiment of a method 1000 of displaying user notes associated with flight charts. The method 1000 may be performed by the electronic flight bag 102 and may be performed using the display 802 of FIG. 8. The method 1000 includes receiving input corresponding to a search request, at 1002. For example, a user may use the search option 804 of FIG. 8 to generate a search request. To illustrate, the search request may include a request to search the one or more user notes 124 based on a search term, a user note category (e.g., personal, non-personal, etc.), a date, a chart number, a note identifier, a geographical region, a chart category (e.g., reference, company, standard terminal arrival, approach, taxi, standard instrument departure), other search criteria, or any combination thereof.

The method 1000 may further include generating a display that identifies a plurality of user notes, where the display indicates one or more flight charts associated with a particular user note of the plurality of user notes, at 1004. For example, in response to the search request, the display 802 of FIG. 8 may be updated to include the one or more entries 806, 808, 810, 812. An entry (e.g., entry 806) may be associated with multiple flight charts (e.g., flight charts 16-1 and 11-9).

The method 1000 may enable a user to search for user notes based on various search criteria including categories associated with flight charts. A user may view user notes associated with a plurality of flight charts (e.g., flight charts included in the same category). Thus, the method 100 may add convenience to a user experience with an electronic flight bag.

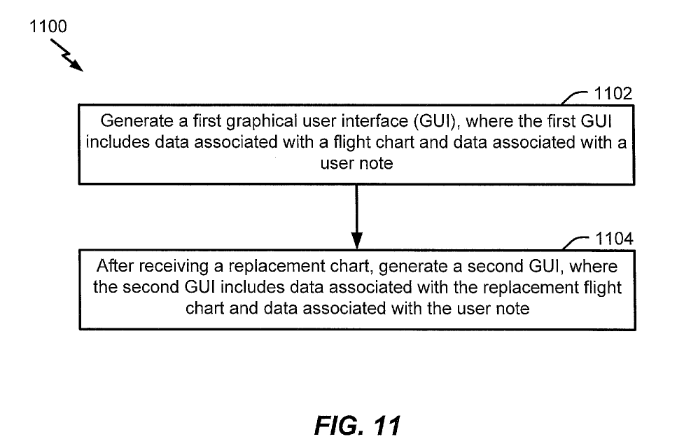

FIG. 11 is a flowchart depicting an exemplary embodiment of a method 1100 of displaying a replacement chart. The method 1100 may be performed by the electronic flight bag 102 and may be performed using the display 402 of FIG. 7. The method 1100 includes generating a first graphical user interface (GUI), where the first GUI includes data associated with a flight chart and data associated with a user note, at 1102.

The method 1100 further includes, after receiving a replacement chart, generating a second GUI, where the second GUI includes data associated with the replacement flight chart and data associated with the user note, at 1104.

The method 1100 enables a user to update a flight chart and view user notes corresponding to the flight chart overlaid on the updated flight chart. A user note is note deleted upon updating the flight chart.

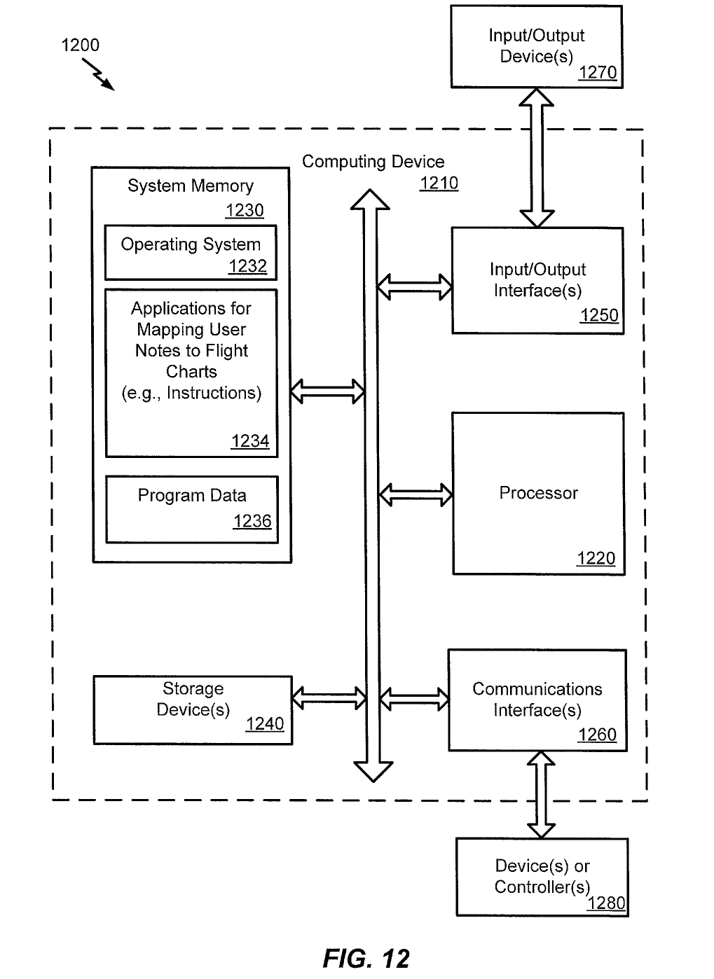

FIG. 12 is an illustration of a block diagram of a computing environment 1200 including a general purpose computing device 1210 configured to support embodiments of computer-implemented methods and computer-executable program instructions (or code) according to the present disclosure. For example, the computing device 1210, or portions thereof, may execute instructions to receive input corresponding to a user note, to generate data that maps the user note to a flight chart identifier associated with a flight chart, to receive a replacement flight chart, and to store the replacement flight chart such that the flight chart identifier is associated with the replacement flight chart. The computing device 1210, or portions thereof, may further execute instructions according to any of the methods described herein.

The computing device 1210 may include a processor 1220. The processor 1220 may communicate with the system memory 1230, one or more storage devices 1240, one or more input/output interfaces 1250, one or more communications interfaces 1260, or a combination thereof. The computing environment 1200 may be the electronic flight bag 102 of FIG. 1. For example, the processor 1210 may correspond to the processor 110 of FIG. 1, and the memory 1230 may correspond to the memory 120 of FIG. 1.

The system memory 1230 may include volatile memory devices (e.g., random access memory (RAM) devices), nonvolatile memory devices (e.g., read-only memory (ROM) devices, programmable read-only memory, and flash memory), or both. The system memory 1230 may include an operating system 1232, which may include a basic/input output system for booting the computing device 1210 as well as a full operating system to enable the computing device 1210 to interact with users, other programs, and other devices. The system memory 1230 may include one or more applications 1234 which may be executable by the processor 1220. For example, the one or more application 1234 may include instructions executable by the processor 1220 to receive input corresponding to a user note, to generate data that maps the user note to a flight chart identifier associated with a flight chart, to receiving a replacement flight chart, and to store the replacement flight chart such that the flight chart identifier is associated with the replacement flight chart. The system memory 1230 may include program data 1236 usable for mapping user notes to flight charts. For example, the system memory 1230 may include the one or more user notes 124, the one or more flight charts 122, the flight chart data structure 126, and the user note data structure 128 of FIG. 1.

The processor 1220 may also communicate with one or more storage devices 1240. For example, the one or more storage devices 1240 may include nonvolatile storage devices, such as magnetic disks, optical disks, or flash memory devices. The storage devices 1240 may include both removable and non-removable memory devices. The storage devices 1240 may be configured to store an operating system, images of operating systems, applications, and program data. In a particular embodiment, the memory 1230, the storage devices 1240, or both, include tangible computer-readable media.

The processor 1220 may also communicate with one or more input/output interfaces 1250 that enable the computing device 1210 to communicate with one or more input/output devices 1270 to facilitate user interaction. The input/output interfaces 1250 may include serial interfaces (e.g., universal serial bus (USB) interfaces or Institute of Electrical and Electronics Engineers (IEEE) 1394 interfaces), parallel interfaces, display adapters, audio adapters, and other interfaces. The input/output devices 1270 may include keyboards, pointing devices, displays, speakers, microphones, touch screens, and other devices. The processor 1220 may detect interaction events based on user input received via the input/output interfaces 1150. Additionally, the processor 1220 may send a display to a display device via the input/output interfaces 1250. The input/output interfaces 1250 may correspond to the input interface 114 and the display interface 112 of FIG. 1.

The processor 1220 may communicate with devices or controllers 1280 via the one or more communications interfaces 1260. The one or more communications interfaces 1260 may include wired Ethernet interfaces, IEEE 802 wireless interfaces, other wireless communication interfaces, or other network interfaces. The devices or controllers 1280 may include host computers, servers, workstations, and other computing devices.

Thus, in particular embodiments, the computer device 120 may be usable to enable mapping user notes to flight charts. For example, the applications 1234 may be executable by the processor 1220 to receive input corresponding to a user note, to generate data that maps the user note to a flight chart identifier associated with a flight chart, to receive a replacement flight chart, and to store the replacement flight chart such that the flight chart identifier is associated with the replacement flight chart.

Embodiments described above are illustrative and do not limit the disclosure. It is to be understood that numerous modifications and variations are possible in accordance with the principles of the present disclosure.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, method steps may be performed in a different order than is shown in the figures or one or more method steps may be omitted. Accordingly, the disclosure and the figures are to be regarded as illustrative rather than restrictive.

Moreover, although specific embodiments have been illustrated and described herein, it should be appreciated that any subsequent arrangement designed to achieve the same or similar results may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the claimed subject matter may be directed to less than all of the features of any of the disclosed embodiments.

What is claimed is:

1. A method comprising:
receiving, at an electronic flight bag device, input corresponding to a user note;
generating, at the electronic flight bag device, data that maps the user note to a flight chart identifier associated with a flight chart;
receiving a replacement flight chart, wherein the replacement flight chart corresponds to an updated version of the flight chart; and
storing the replacement flight chart such that the flight chart identifier is associated with the replacement flight chart.

2. The method of claim 1, wherein the input is received via a touchscreen interface, a keyboard interface, or both.

3. The method of claim 1, further comprising, before receiving the input, receiving second input corresponding to a request to make a new note and generating an empty user note in response to the second input, wherein the user note is based on the empty user note.

4. The method of claim 1, further comprising, before receiving the replacement flight chart:
generating a display based on the flight chart, wherein the display includes an indicator indicating that the user note is mapped to the flight chart; and
in response to selection of the indicator, updating the display to overlay the user note on the flight chart, wherein the user note is at least partially transparent.

5. The method of claim 4, further comprising automatically sizing the user note within the display based on a number of user notes associated with the flight chart identifier.

6. The method of claim 1, further comprising generating data that maps the user note to a second flight chart identifier associated with a second flight chart.

7. The method of claim 1, further comprising:
receiving second input corresponding to the user note, wherein the second input comprises a request to edit or delete the user note; and
editing or deleting the user note for a plurality of flight charts associated with the user note in response to the second input.

8. The method of claim 7, wherein the plurality of flight charts includes each flight chart associated with a particular geographical area.

9. The method of claim 1, further comprising generating a display that identifies a plurality of user notes, and wherein the display indicates one or more flight charts associated with a particular user note of the plurality of user notes.

10. A non-transitory computer-readable medium storing instructions that, when executed by a processor, cause the processor to perform operations comprising:
receiving input corresponding to a user note;
generating data that maps the user note to a flight chart identifier associated with a flight chart;
receiving a replacement flight chart, wherein the replacement flight chart corresponds to an updated version of the flight chart; and
storing the replacement flight chart such that the flight chart identifier is associated with the replacement flight chart.

11. The non-transitory computer-readable medium of claim 10, wherein the operations further comprise:
receiving input corresponding to a second user note; and
generating data that maps the second user note to the flight chart identifier.

12. The non-transitory computer-readable medium of claim 10, wherein the operations further comprise:
generating a first graphical user interface (GUI), wherein the first GUI includes data associated with the flight chart and data associated with the user note; and
after receiving the replacement chart, generating a second GUI, wherein the second GUI includes data associated with the replacement flight chart and data associated with the user note.

13. The non-transitory computer-readable medium of claim 10, wherein the operations further comprise generating a graphical user interface (GUI) including the flight chart and a translucent display of the user note overlaying at least a portion of the flight chart.

14. The non-transitory computer-readable medium of claim 10, wherein the operations further comprise:
receiving second input corresponding to a search request; and
generating a graphical user interface (GUI), wherein the GUI includes data associated with a plurality of user notes that correspond to the search request.

15. The non-transitory computer-readable medium of claim 10, wherein the operations further comprise storing data categorizing the user note as personal or non-personal.

16. A system comprising:
a processor; and
a memory accessible to the processor, the memory storing:
a flight chart data structure, wherein a flight chart is identified within the flight chart data structure by a flight chart identifier, wherein the flight chart identifier is distinct from a version identifier corresponding to the flight chart; and
a note data structure, wherein a user note of the note data structure is mapped to the flight chart using the flight chart identifier; and
a display interface accessible to the processor to send data corresponding to the flight chart and data corresponding to the user note to a display device.

17. The system of claim 16, wherein the flight chart identifier is a flight chart index number, and wherein the flight chart comprises a terminal chart, an en-route chart, a sectional chart, or a combination thereof.

18. The system of claim 16, wherein the user note is mapped within the note data structure to a second flight chart using a second flight chart identifier.

19. The system of claim 16, wherein the note data structure is unchanged when the flight chart is updated.

20. The system of claim 16, wherein the user note is automatically mapped to a set of flight charts based on user input regarding the set.
